(19) United States
(12) Patent Application Publication
(10) Pub. No.: US 2001/0016677 A1
(43) Pub. Date: Aug. 23, 2001

(54) INCUBATOR WITH THERMOELECTRIC COOLER

(76) Inventors: DAN RUSSELL POOLE, AUSTIN, TX (US); ALVIN JOHN SEGARS, FORTH WORTH, TX (US)

Correspondence Address: ANDREA PAIR BRYANT, HUGHES & LUCE, 111 CONGRESS AVENUE, SUITE 900, AUSTIN, TX, 78701

(21) Appl. No.: 09/250,454

(22) Filed: Feb. 16, 1999

(51) Int. Cl. A61G 11/00

(52) U.S. Cl. 600/22

(57) ABSTRACT

An incubator is described which uses a thermoelectric cooler (TEC) as a heat pump in order to provide a stable temperature environment in the infant chamber. Use of a TEC allows a preselected temperature to be maintained in a large range of ambient temperatures during transport, with improved operating efficiency.

### BACKGROUND OF THE INVENTION

1. Technical Field

The present invention relates to incubators. More particularly, it relates to improvements in the operating efficiency of incubators which improvements derive from the use of a thermoelectric cooler as a heat pump for providing a stable thermal environment for an infant in an infant chamber of the incubator.

2. Background of the Invention

Infant incubators are designed to provide a stable thermal environment for neonatal infants whose own thermoegulation systems are too immature to maintain their body temperature. Neonatal infants may be required to be in an incubator from a few days to several weeks depending on the maturity of the infant. The air temperature in an incubator is typically maintained near body temperature of 37° C. Some incubators control the air temperature based upon the skin temperature of the infant. Visibility of the infant is an important concern and most incubator infant chambers are constructed of a clear plastic such as Plexiglas, offering clear views of the infant from five sides. Unfortunately, the Plexiglas is not a good thermal insulator. There have been studies indicating the benefit using a double wall infant chamber, which helps reduce the thermal loss due to the air layer between the two walls of the chamber. More importantly the double wall chamber maintains a higher inner wall temperature, which reduces the radiative heat loss of the infant.

Transport incubators, which have been in existence for over 30 years, are designed to provide a stable thermal environment for the neonatal infant during transport, such as transport to a hospital with the appropriate critical care facilities or possibly transport within the hospital itself. Transport can last from a few minutes, such as transport within the hospital, or can be several hours when the infant must be moved large distances. Incubators designed for use within the hospital operate in a controlled thermal environment (20° C. to 30° C.) and have access to virtually unlimited electrical, since they plug into wall outlets power from the mains outlet. On the other hand, incubators operate in a wider possible range of temperatures (−20° C. to 40° C.) and often have no access to external power sources. Internal batteries must be used to provide a power source. Lead-acid batters are most commonly used because of their reliability and their ability to provide high rates of discharge when large amounts of heat are required in cold environments. Unfortunately, lead-acid batteries are heavy and reducing weight is an important concern both for the transport personnel who at times must lift the incubator and for those people wanting to reduce payload in weight sensitive aircraft.

Heat loss through natural convection and radiation of the infant chamber must be replaced. The heat to be replaced determines the size of battery required for a given operating time. Efforts to reduce heat loss can be made, but are usually limited by the need for visibility of the infant and the use of practical materials and construction. Typical heat loss from the infant chamber with an air temperature of 37° C. and ambient temperature of 23° C. can range from 30 watts to 100 watts, depending on the size and construction of the infant chamber. Air flow patterns in the infant chamber can also have a significant effect of the amount of heat loss.

Typically resistive heaters have been used in all incubators to provide the source of heat. A resistive heater requires a battery to provide the heat loss by the infant chamber. Heat loss is used here to mean loss of energy while power loss represents the rate of heat loss. The theoretical minimum power required to raise 30 joules of heat per second from 23° C. to 37° C. is 1.4 watts, as determined from the second law of thermodynamics. In practice the power required is considerably greater due to practical considerations. Compressors may be used to accomplish the heat transfer, but the increased complexity and expense associated therewith makes use in incubators not practical.

### DESCRIPTION OF THE RELATED ART

U.S. Pat. No. 3,918,432 to Franz et al. relates to a method of heating an incubator during transport without the use of an external supply of electrical power. The reference describes the known electrically heated incubators.

The prior art teaches various mechanisms for heating/keeping air in the infant chamber of incubators. Yet the problem of maintaining a predetermined infant chamber temperature remains when the temperature of the ambient air is above that desired as well as when the ambient air temperature is below that desired. Further, it is also desirable to decrease the power required while prolonging the operating time.

U.S. Pat. No. 5,240,857 to Lahetkangas relates to a temperature gradient incubator for studying temperature dependent phenomena. This reference describes cooling as well as heating. An incubator as described, is not suitable for transport of human infants.

Representative prior art techniques for maintaining the interior of an incubator at an appropriate temperature are found in the following U.S. patents: U.S. Pat. No. 3,876,859 to Franz; U.S. Pat. No. 3,919,999 to Gluck et al.; U.S. Pat. No. 4,458,674 to Lemburg et al.; U.S. Pat. No. 4,681,090 to Koch; U.S. Pat. No. 4,846,783 to Koch et al.; U.S. Pat. No. 5,018,931 to Uttley; U.S. Pat. No. 5,100,375 to Koch; U.S. Pat. No. 5,186,710 to Koch et al.; U.S. Pat. No. 5,534,669 to Schroeder et al.; U.S. Pat. No. 5,707,337to Franz; and U.S. Pat. No. 5,773,287 to Binder.

### BRIEF SUMMARY OF THE INVENTION

The present invention uses a thermoelectric cooler (TEC) to pump the heat from ambient temperature to the chamber temperature in order to reduce the power required from internal batteries in an incubator. The use of a heat pump has the added advantage of providing the ability to remove heat from the infant chamber as required in hotter ambient temperatures or when a significant source of radiative heat, such as the sun, is present.

A TEC presents a hot or cold side to a heatsink in the base of the infant chamber as a function of the direction of current supplied thereto.

### BRIEF DESCRIPTION OF THE DRAWINGS

For a more complete understanding of the present invention and the advantages thereof, reference should be made to the following Detailed Description taken in connection with the accompanying drawings wherein like reference numerals are used throughout to denote the same elements and in which:

FIG. 1 is a schematic illustration of an incubator;

FIG. 2 shows a prior art mechanism for heating the interior of the incubator of FIG. 1;

FIG. 3 shows the heating mechanism of the present invention; and

FIG. 4 shows the heating mechanism of FIG. 3 installed in an incubator.

### DETAILED DESCRIPTION OF THE PREFERRED EMBODIMENT

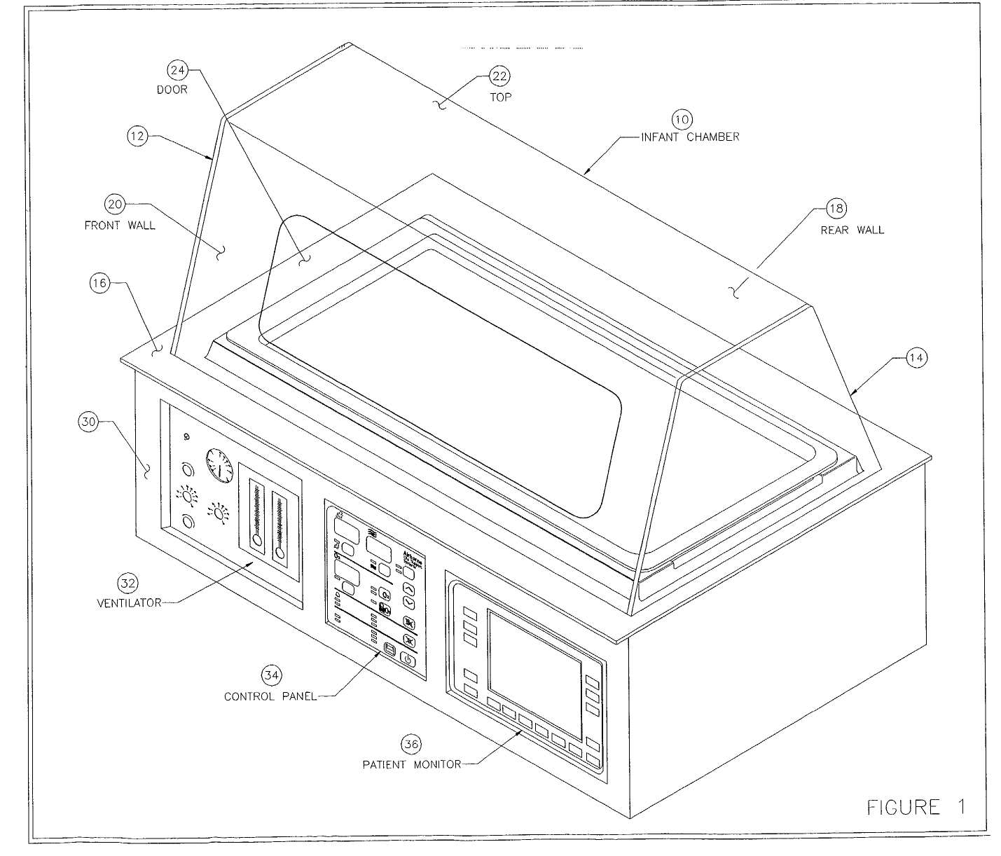

FIG. 1 shows the primary external characteristics of an incubator. Infant chamber 10 is defined by side walls 12 and 14, a base 16, rear wall 18, front wall 20 and a top 22. Care giver access to infant chamber 10 occurs through appropriate openings in door 24 and infant wall 20. Those skilled in the art will understand that other conventional access ports, playing no essential role in the present invention, are not shown.

Infant chamber 10 rests in and is operably connected to control unit 30. Schematically illustrated are a ventilator 32, temperature control panel 34 and patient monitor device 36. Control unit 30 includes within its housing a mechanism for heating the interior of infant chamber 10.

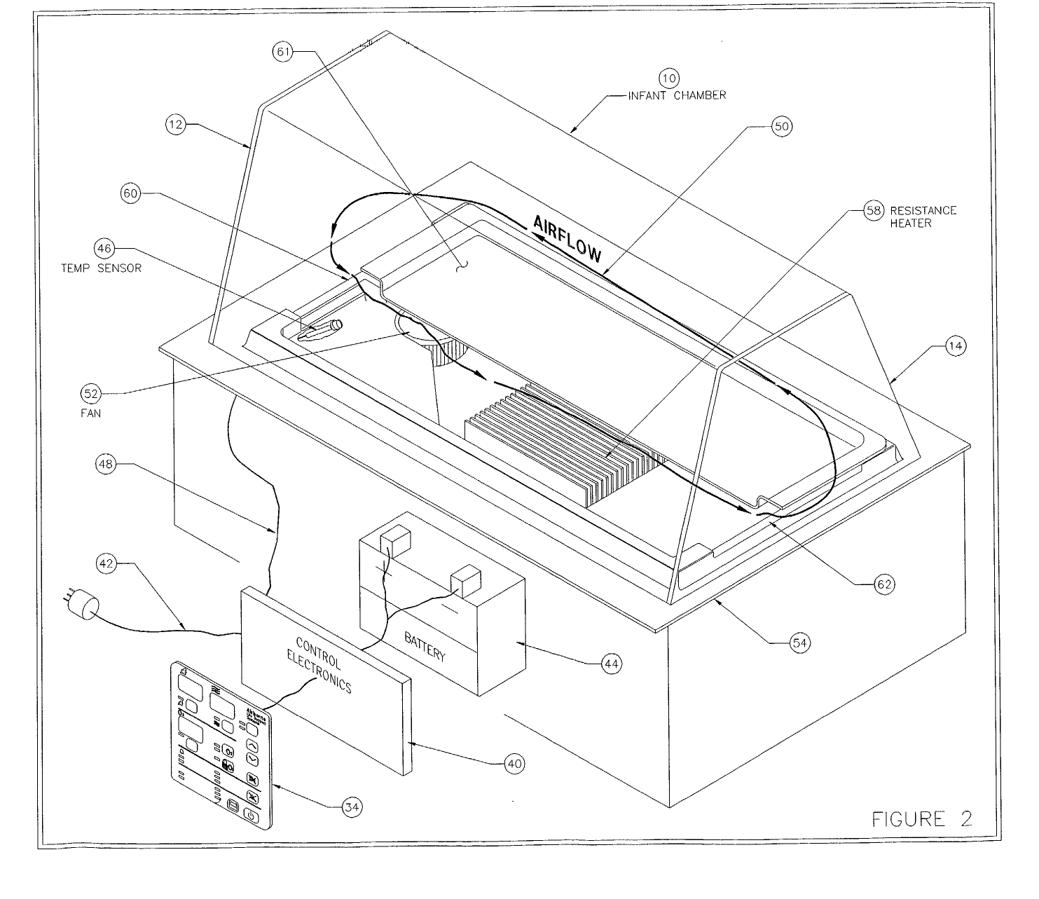

FIG. 2 illustrates a prior art heating mechanism used with an incubator such as that shown in FIG. 1. Control electronics unit 40 is interconnected to temperature control panel 34. Electrical power is supplied from wall current via line 42 or from a battery 44.

A temperature sensor 46 provides data over line 48 to control electronics unit 40. Temperature sensor 46 is located in the ambient air at a point in air flow path 50 upstream of a fan 52 which draws ambient air through a channel defined by the bottom of infant chamber 10 and base wall 54. A resistance heater 58 is located in air flow path 50. The operation of resistance heater 58 is controlled by control electronics unit 40 as a function of the temperature sensed by sensor 46. Air flow path 50 continues counter clockwise through an opening 60 formed by base wall 54 and mattress tray 61, through infant chamber 10. Air is exhausted through an opening 62 formed by base wall 54 and mattress tray 61.

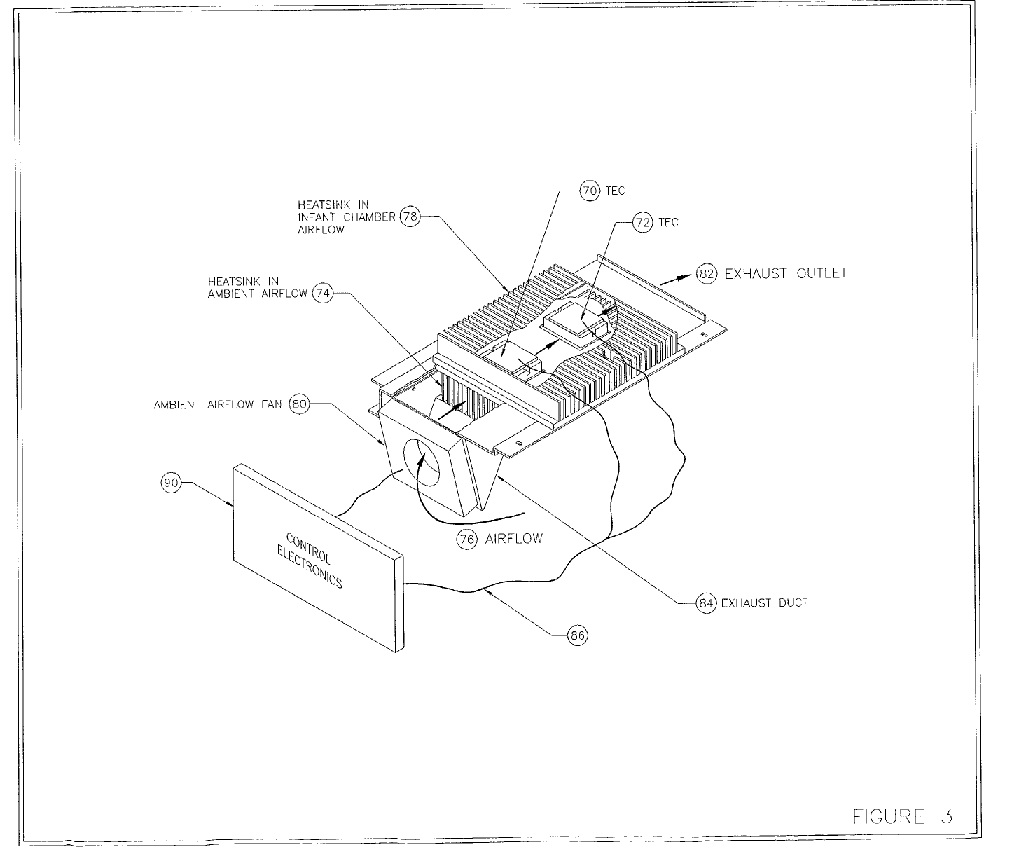

Refer now to FIG. 3 for a better understanding of the improved technique of the present invention for providing and maintaining a stable temperature environment within the infant chamber 10 of an incubator. Two TECs, 70 and 72, are shown. TECs 70, 72 are solid state devices which use the Peltier effect to pump heat. They are commonly made from bismuth telluride and the direction of current flow can be reversed to change the direction of heat flow. The efficiency of the TEC is reduced by resistive heat generation and by thermal conductivity between the cold and hot junctions. TECs have an optimal operating point based upon the cold and hot junction temperatures and the geometry of their individual elements. There are a variety of the TECs available with differing geometries and number of elements. Generally performance is increased by reducing the thermal resistance of the heatsinks used for the cold and hot junctions.

In FIG. 3, the temperature maintenance apparatus of the present invention is shown. Heatsink 74 is provided in the ambient airflow path 76. As opposed to the prior art implementation illustrated in FIG. 2 which uses only one heatsink (58), the present invention requires two heatsinks. A second heatsink 78 is provided for the hot junction when heating infant chamber 10 or the cold junction, when cooling infant chamber 10. The thermal resistance of both heatsinks 74 and 78 must be kept to a minimum for best TEC performance. When using a resistive heater of the prior art, thermal resistance of the heater to air is relatively unimportant. An ambient airflow fan 80 is provided for drawing ambient air in to follow airflow path 76 through the chamber temperature maintenance apparatus. Airflow outlet 82 and exhaust duct 84.

TECs 70, 72 are connected via split line 86 to control electronics unit 90. Control electronics unit 90 is also operatively connected to ambient airflow fan 80.

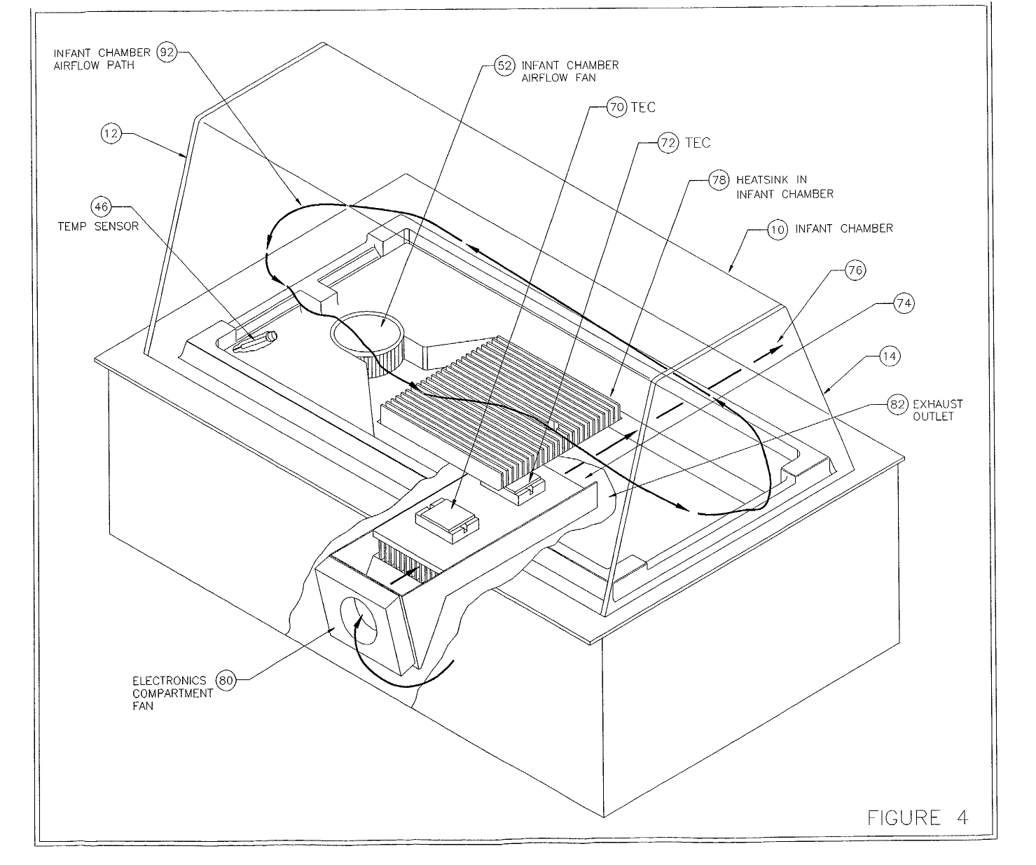

FIG. 4 is a perspective view of an incubator with the improved temperature maintenance scheme of the present invention, shown in FIG. 3, installed. For ease of understanding a mattress tray comparable to mattress tray 61 in FIG. 1 has been omitted from the figure. As shown, there are two airflow paths 76 and 92, each with its own fan, 80 and 52, respectively. Infant chamber 10 surrounds airflow path 92 which airflow is used to transfer heat to or from TECs 70 and 72, which are in planar contact with infant chamber heatsink 78.

Ambient airflow path 76 transfers heat to or from TECs 70, 72 to the ambient air.

The operation of an incubator embodying the present invention is as follows. TECs 70, 72 draw heat from the ambient air to raise the temperature of infant chamber 10. Ambient air is pumped to heatsink 78. When the temperature inside infant chamber 10 needs to be lowered, the direction of current supplied to TECs 70,72 is reversed and ambient airflow heatsink 74 is used to exhaust heat from the infant chamber 10. To further improve the operating efficiency, the ambient airflow path includes and draws heat from the heat generating control electronics interior of the electronics control housing 30.

Current to the TECs 70, 72 is controlled by use of a digital implementation of a PID feedback loop, based upon the error temperature between the desired operating temperature and the temperature sensed by sensor 46 for infant chamber 10.

While the present invention has been described having reference to a particular preferred embodiment, those having skill in the art will understand that various changes in form and detail without departing from the scope of the following claims.

What is claimed is:

1. An improved transport incubator including an infant chamber comprising:
means for maintaining a preselected temperature, above or below ambient air temperature.

2. The transport incubator of claim 1 additionally including:
a heatsink in planar contact with a first side of a thermoelectric cooler, said heatsink being located in the infant chamber air flow path;
another heatsink in planar contact with an opposing side of said thermoelectric coolers said other heatsink being located in ambient airflow; and
means for adjusting current flow direction to said thermoelectric cooler as a function of whether said preselected temperature is above or below infant chamber temperature.

3. The transport incubator of claim 1 wherein:
said means for maintaining said preselected temperature includes a heat pump;
means in said infant chamber for sensing infant chamber temperature; and
means responsive to said sensing means for reversing heat pump operating direction to raise or lower said infant chamber temperature.

4. The transport incubator of claim 3 wherein said heat pump comprises at least a thermoelectric cooler.

5. The transport incubator of claim 4 wherein:
said at least one thermoelectric cooler has a first side in planar contact with a heatsink in an airflow path through said infant chamber; and
a second side in planar contact with a heatsink in an airflow path in ambient air.

6. A method of maintaining an incubator infant chamber temperature at a preselected temperature comprising the steps of:
providing in infant chamber portion of air flow path a heatsink in planar contact with a first side of at least one thermoelectric cooler;
providing in ambient air flow path heat sink in planar contact with an opposing side of said at least one thermoelectric cooler; and
adjusting current flow direction to said at least one thermoelectric cooler as a function of whether infant chamber temperature is above or below said preselected temperature.

7. The method of claim 6 additionally including the steps of:
constraining ambient airflow path to include intaking air in contact with electronic components interior of said incubator; and
exhausting heated air through a vent.

8. The method of claim 7 wherein said adjusting step includes:
determining infant chamber temperature;
comparing infant chamber air temperature with said preselected temperature; and
responsive to said comparing step, changing direction of current flow to said at least one thermoelectric cooler.

9. The method of claim 8 wherein said changing step includes:
providing current flow in a first direction for raising infant chamber temperature; and
providing current flow in a direction reversed from said first direction for lowering infant chamber temperature.

10. Apparatus for maintaining a uniform preselected temperature in an infant chamber of a transport incubator comprising:
at least one thermoelectric cooler sandwiched between a heatsink in said infant chamber and a heatsink in an ambient airflow path;
means for sensing said infant chamber airflow temperature;
means for comparing said preselected temperature and said infant chamber airflow temperature; and
means responsive to said comparing means for providing current flow to said thermoelectric cooler in a first direction heating said heatsink in said infant chamber when said ambient airflow temperature is lower than said preselected temperature and means for reversing said current flow direction, cooling said infant chamber heatsink, when said preselected temperature is lower than said ambient airflow temperature.

11. A transport incubator including an infant chamber and means for providing improved operating efficiency comprising:
a heat pump for maintaining a preselected temperature in said infant chamber.

12. The transport incubator of claim 11 wherein said heat pump is a thermoelectric cooler.

13. The transport incubator of claim 12 additionally including:
a heatsink in planar contact with a first side of said thermoelectric cooler, said heatsink being located in the infant chamber air flow path;
another heatsink in planar contact with an opposing side of said thermoelectric coolers said other heatsink being located in ambient airflow; and
means for adjusting current flow direction to said thermoelectric cooler as a function of whether said preselected temperature is above or below infant chamber temperature.

14. An incubator including an infant chamber and means for providing improved operating efficiency comprising:
a heat pump for maintaining a preselected temperature in said infant chamber.

15. The incubator of claim 14 wherein said heat pump is a thermoelectric cooler.

16. The incubator of claim 15 additionally including:
a heatsink in planar contact with a first side of said thermoelectric cooler, said heatsink being located in the infant chamber air flow path;
another heatsink in planar contact with an opposing side of said thermoelectric coolers said other heatsink being located in ambient airflow; and
means for adjusting current flow direction to said thermoelectric cooler as a function of whether said preselected temperature is above or below infant chamber temperature.
